(19) United States
(12) Patent Application Publication
(10) Pub. No.: US 2009/0016907 A1
(43) Pub. Date: Jan. 15, 2009

(54) DYNAMIC BALANCER WITH SPEED-RELATED CONTROL MECHANISM

(76) Inventors: Matthew Williamson, Richmond Hill (CA); David R. Shulver, Richmond Hill (CA)

Correspondence Address: MAGNA INTERNATIONAL, INC., 337 MAGNA DRIVE, AURORA, ON, L4G-7K1, CA

(21) Appl. No.: 12/280,799

(22) PCT Filed: Feb. 27, 2007
(86) PCT No.: PCT/CA2007/000306

§ 371 Date: Aug. 27, 2008

Related U.S. Application Data
(60) Provisional application No. 60/777,802, filed on Feb. 28, 2006.

(51) Int. Cl. F16F 15/26; F16F 15/32; F04C 14/24

(52) U.S. Cl. 417/365; 418/40

(57) ABSTRACT

A dynamic balancer for a prime mover, such as an internal combustion engine, with at least one balance shaft driven by the crankshaft of the engine, the at least one balance shaft. The pressure generator creates an output signal of pressurized working fluid whose pressure is speed-related. In one embodiment, the speed related pressure signal is applied to a device outside the balancer via a suitable the invention, a working fluid pump is also driven by at least one of the balance shafts of the dynamic balancer and the speed-related pressure signal is applied to the working fluid pump to control its output.

### FIELD OF THE INVENTION

The present invention relates to a speed-related control mechanism and method for controlling devices such as pumps or the like. More specifically, the present invention relates to a dynamic balancer system and method for speed-related control wherein a supply of a working fluid is provided at a speed-related pressure to control the operation of a device, such as a pump.

### BACKGROUND OF THE INVENTION

Many mechanisms such as internal combustion engines have working fluid requirements (such as lubricating oil) that vary with the operating speed of the device. Other devices, including automatic transmission systems, etc. also have varying requirements for various working fluids that depend upon the operating speed of the device.

Conventionally, working fluids have been supplied to devices with varying requirements via fixed displacement pumps, whose output pressures are limited by a relief valve system, or via variable displacement pumps, whose displacement can be varied.

Fixed displacement pumps, such as gear or vane pumps, output substantially the same volume of working fluid per revolution independent of the operating speed of the pump. With such systems, the pump is generally designed and sized to supply working fluid to meet worst case operating conditions and the pump thus oversupplies working fluid in many other operating conditions. To prevent this oversupply from damaging the supplied device, a pressure relief valve is typically employed to divert the oversupply from the output of the pump back to the working fluid reservoir of the pump inlet. While such systems work well, they are not energy efficient as energy is used by the pump to produce the oversupply of fluid which is merely diverted.

Variable displacement pumps, such as variable displacement vane pumps, include a control mechanism, such as a control slider, whose position can be altered to alter the pump displacement. Typically, a control mechanism comprising a piston or chamber supplied with pressurized working fluid from the output of the pump acts on the control mechanism, against a counter acting control force such as a biasing spring, to alter the displacement of the pump according to its output pressure. Generally, variable displacement pumps provide improved energy efficiency compared to fixed displacement pump system.

However, the control mechanisms employed for both fixed displacement pumps and variable displacement pumps are only responsive to the output pressure of the pump. In many circumstances the requirements of the device being supplied with working fluid vary with the operating speed of the device and control devices employing the output pressure of the pump do not well match the speed changing requirements of the supplied device.

It is desired to have a control system and method for supplying a working fluid at a speed-related pressure to control the operation of another device, such as a pump.

### SUMMARY OF THE INVENTION

It is an object of the present invention to provide a novel dynamic balancer with a speed-related control mechanism which obviates or mitigates at least one disadvantage of the prior art.

According to a first aspect of the present invention, there is provided a dynamic balancer for a prime mover comprising: at least a first balance shaft with an eccentric counterweight rotatably mounted to the prime mover, the first balance shaft further comprising a pressure generator operable to create a signal of pressurized working fluid whose pressure is related to the rotational speed of the first balance shaft, the signal being available to a controllable device; and an input drive operable to allow the prime mover to rotate the first balance shaft.

The present invention provides a dynamic balancer for a prime mover, such as an internal combustion engine, with at least one balance shaft driven by the crankshaft of the engine. Such dynamic balancers are commonly employed on four cylinder in-line engines and five cylinder in-line engines in dual balance shaft configurations wherein the balance shafts counter rotate. Single shaft dynamic balancers are also employed on some configurations of V6 engines with sixty degree V angles. In both of these dual balance shaft and single balance shaft configurations, the balance shafts are rotated at twice the speed of the crankshaft and in other configurations the balance shaft or shafts can be rotated at the same speed as the crankshaft.

The dynamic balancer includes a pressure generator on the at least one balance shaft which creates an output signal of pressurized working fluid whose pressure is speed-related. In one embodiment, the speed related pressure signal is applied to a device outside the balancer via a suitable passage. In other embodiments of the invention, a working fluid pump is also driven by at least one of the balance shafts of the dynamic balancer and the speed-related pressure signal is applied to the working fluid pump to control its output.

### BRIEF DESCRIPTION OF THE DRAWINGS

Preferred embodiments of the present invention will now be described, by way of example only, with reference to the attached Figures, wherein:

FIG. 1 shows a plan section, taken through line 1-1 of FIG. 2, of a dynamic balancer and speed-related control mechanism in accordance with the present invention;

FIG. 2 shows a side section, taken through line 2-2 of FIG. 1, of the dynamic balancer of FIG. 1;

FIG. 3 shows a plan section, taken through line 3-3 of FIG. 4, of another dynamic balancer and speed-related control mechanism in accordance with the present invention;

FIG. 4 shows a side section, taken through line 4-4 of FIG. 3, of the dynamic balancer of FIG. 3;

FIG. 5 shows a plan section, taken through line 5-5 of FIG. 6, of another dynamic balancer and speed-related control mechanism in accordance with the present invention; and

FIG. 6 shows a side section, taken through line 6-6 of FIG. 5, of the dynamic balancer of FIG. 5.

### DETAILED DESCRIPTION OF THE INVENTION

The present inventor has developed a speed-related control mechanism for pumps which is described in PCT Patent Application WO06032131A1, filed Sep. 20, 2005 and which is assigned to the assignee of the present invention and the contents of this application are incorporated herein by reference.

In the previously described inventive speed-related control mechanism a pressure generator, comprising a disc shaped member defining an annular chamber, is driven with the pump impellor or rotor. The chamber of the pressure generator is supplied with fluid and as the chamber rotates it creates a supply of pressurize fluid which varies with the square of the rotational speed at which it is turning. This pressurizes fluid is used to operate a suitable control mechanism to vary the supply of working fluid from the output of the pump.

While the previous invention provides numerous advantages over prior art systems, it may not be possible to employ the previous invention in some circumstances due to the physical size requirements of the pressure generator. Specifically, the pressure produced by the pressure generator is given by:

$${p}_{o} - {p}_{i} = \frac{ρ \cdot {ω}^{2}}{2} \cdot ( {r}_{o}^{2} - {r}_{i}^{2} )$$

where pₒ is the pressure in Pascals at the outlet port(s) of the annular chamber, pᵢ is the pressure in Pascals at the inlet port(s) of the annular chamber, □ is the density of the working fluid in kg/m³, ω is the speed at which the annular chamber is rotated in rad/sec, rᵢ is the distance in meters of the inlet port(s) from the rotational center of the annular chamber and rₒ is the distance in meters of the outlet port(s) from the rotational center of the annular chamber. As is apparent from the above, to produce a desired pressure for a given working fluid and operating speed some minimum radius must be available for rₒ and, if sufficient space is not available in an application, the previous inventive pressure generator solution cannot be deployed.

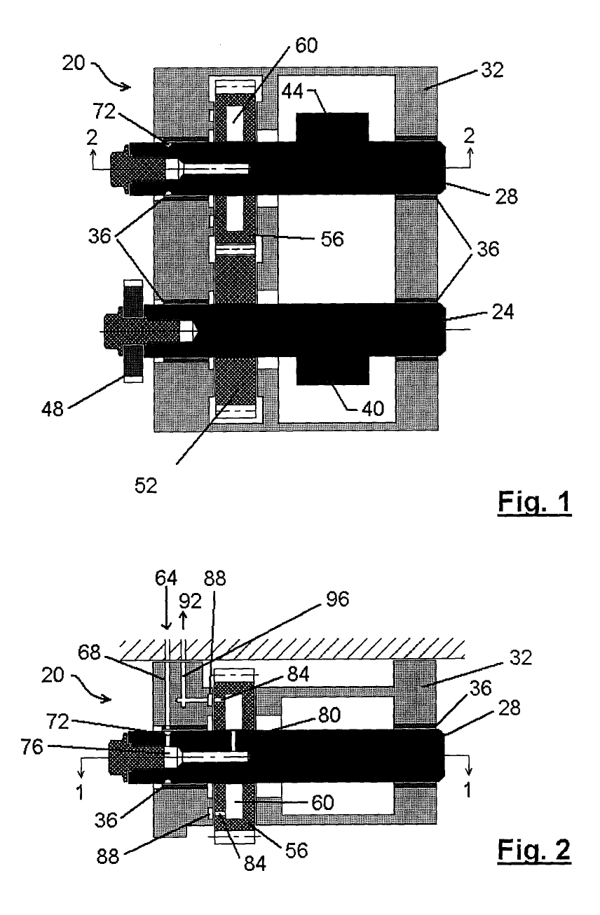

A dynamic balancer with a speed-related control mechanism, in accordance with the present invention, is indicated generally at 20 in FIGS. 1 and 2. Dynamic balancers of this type are used with many four cylinder in-line internal combustion engines to reduce operating vibrations, resulting from kinetic imbalances as the pistons of the engine reciprocate with non-sinusoidal velocities as determined by connecting rod linkages and geometries. Typically, the dynamic balancers are located in the engine sump and are synchronously driven by a chain, or gear from the engine crankshaft at a speed twice that of the crankshaft, although in some configurations they may be driven at the same speed as the crankshaft. The dynamic balancers can include two counter-rotating shafts with eccentrically located balance weights, or a single balance shaft with one or more eccentric weights, and whose rotation counters the kinetic imbalance to reduce the net imbalance and vibration of the engine.

As shown, balancer 20 includes first and second balance shafts 24, 28 which are mounted to a housing 32 by journal bearings 36 which permit the rotation of balance shafts 24 and 28 within housing 32. Balance shaft 24 includes an eccentrically mounted balance weight 40 and balance shaft 28 includes an eccentrically mounted balance weight 44.

Balance shaft 24 further includes a drive gear or sprocket 48 which is synchronously driven by the engine crankshaft (not shown). In many applications balance shaft 24 is rotated at twice the speed of the engine crankshaft and this is achieved by the gear ratio between drive gear 48 and the engine crankshaft gear. In other environments, balance shaft 24 can be rotated at the same speed as the crankshaft.

Balance shaft 24 also includes a gear 52 which is complementary to and engages a gear 56 on balance shaft 28 such that, as balance shaft 24 rotates, balance shaft 28 counter-rotates at the same speed.

As illustrated, gear 56 on balance shaft 28 includes a chamber 60 formed within and which encircles balance shaft 28. Chamber 60, which can be generally any shape but which is shown as being annular in FIGS. 1 and 2, is supplied with working fluid from a working fluid supply 64, via a passage 68 in housing 32 which is in fluid communication with a groove 72 on the exterior of balance shaft 28 via a feed bore through journal bearing 36.

Groove 72 is in fluid communication with an axially extending central passage 76 in balance shaft 28 which is, in turn, in fluid communication with chamber 60 via a radially extending connecting passage 80. As will now be apparent, chamber 60 is supplied with working fluid from working fluid supply 64 and chamber 60 will be substantially filled with working fluid under normal operating conditions.

Chamber 60 further includes at least one outlet 84, and in the illustrated embodiment two outlets 84, for working fluid which is pressurized in chamber 60 as balance shaft 28 is rotated. Outlets 84 are positioned radially outwardly relative to the connecting passage 80. The face of gear 56 is in substantially sealed thrust engagement with the adjacent wall of housing 32 which acts as a thrust face and in which an annular groove 88 is formed to receive pressurized working fluid from outlets 84 as the gear 56 rotates. Groove 88 is in fluid communication with a speed-related pressurized working fluid outlet 92 via a passage 96 in housing 32.

As will now be apparent to those of skill in the art, working fluid from supply 64 is pressurized in chamber 60, which acts as a pressure generator, at a rate proportional to the square of the rotational speed of balancer shaft 28 which rotates at twice the speed of the crankshaft of the engine driving balancer 20. Thus, the pressure of the working fluid provided at outlet 92 is speed-related and can be used to control various devices such as lubrication pumps etc. In particular, the pressurized working fluid at outlet 92 can be used as a control means to vary the displacement of a variable displacement lubrication pump or as a control means to vary the release pressure of a pressure relief valve used in conjunction with a fixed displacement lubrication pump.

As will now also be apparent, one of the advantages of the present invention over the speed-related control system described in the above-mentioned PCT Patent Application WO06032131A1 is obtained when balancer 20 operates at twice the crankshaft speed. Under these circumstances chamber 60 rotates at twice the speed of the engine crankshaft driving balancer 20 and from:

$${p}_{o} - {p}_{i} = \frac{ρ \cdot {ω}^{2}}{2} \cdot ( {r}_{o}^{2} - {r}_{i}^{2} )$$

it can be seen that when the rotational speed ω of chamber 60 is doubled, the radii required for chamber 60 to produce a given pressure are substantially reduced. Thus by employing the higher operating speed of balancer 20, which is twice that of the crankshaft of the engine, a speed-related output pressure can be created with a chamber 60 of a smaller size than previously required, thus permitting a speed-related control mechanism to be employed in a greater range of circumstances.

While balancer 20 is illustrated with chamber 60 formed in gear 56, the present invention is not so limited and chamber 60 can be formed in a variety of manners providing only that chamber 60 be formed such that a volume of working fluid extends radially from the axis of revolution of at least one of balance shafts 24 or 28. For example, chamber 60 can be formed in one of balance weights 40 or 44 if desired.

If desired, for example for a V6 engine with a sixty degree V angle, balancer 20 can be fabricated with a single balance shaft 28 and, in such a case, drive gear or sprocket 48 will be mounted on balance shaft 28.

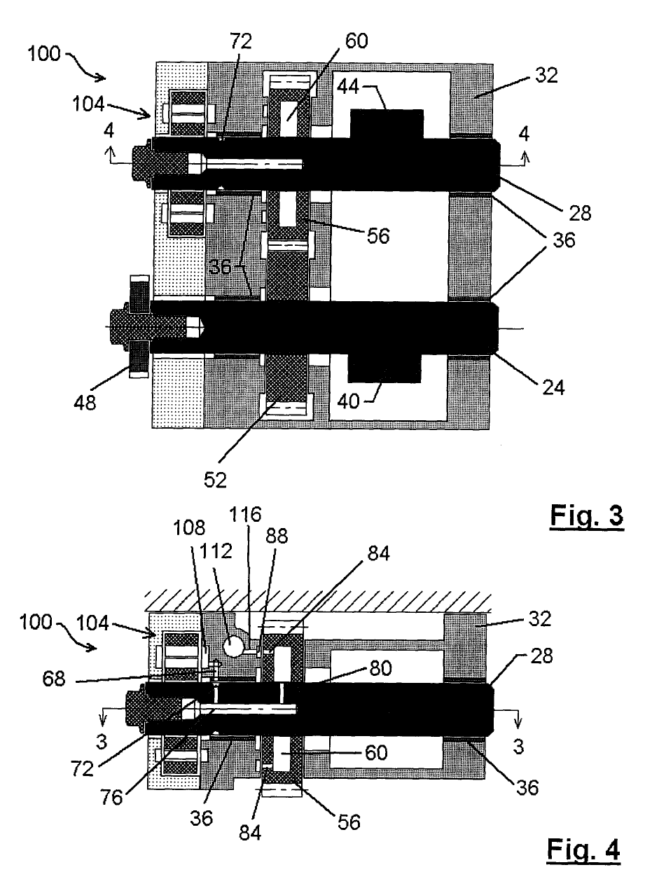

FIGS. 3 and 4 show another dynamic balancer 100 with a speed-related control mechanism in accordance with the present invention and wherein like components to those of the embodiment of FIGS. 1 and 2 are indicated with like reference numerals. Balancer 100 includes a fixed displacement pump 104 which is driven by balancer shaft 28. In the illustrated embodiment, fixed displacement pump 104 is a gerotor pump but it should be understood by those of skill in the art that any suitable fixed displacement or variable displacement pump can be employed, including gear pumps and/or vane pumps, etc. if desired.

As best seen in FIG. 4, pump 104 includes a low pressure inlet port 108 which is connected to a working fluid supply (not shown). Low pressure inlet port 108 is also connected to center bore 76 of balance shaft 28 by passage 68 and groove 72 and low pressure working fluid is supplied to chamber 60 from center bore 76 via connecting passage 80.

Chamber 60 includes at least one outlet 84, and in the illustrated embodiment two outlets are provided, for working fluid which is pressurized in chamber 60 as balance shaft 28 is rotated. The face of gear 56 is in substantially sealed engagement with the adjacent wall of housing 32 which acts as a thrust face and in which a groove 88 is formed to receive pressurized working fluid from outlets 84. Groove 88 is in fluid communication with a pressure relief valve bore 112 via a passage 116 such that working fluid from chamber 60 with a speed-related pressure is introduced into valve bore 112.

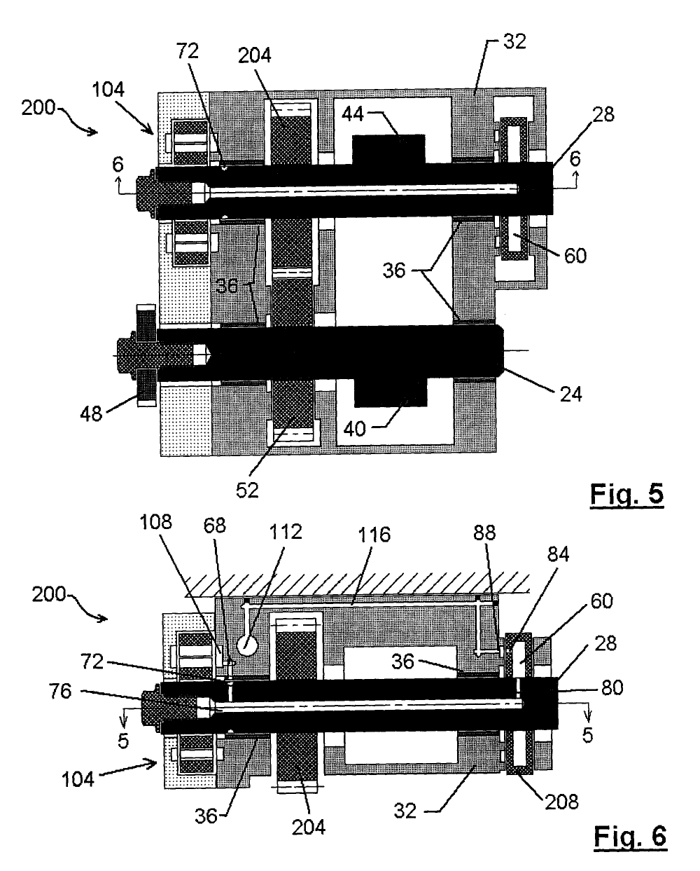

Valve bore 112 contains a pressure relief valve (not shown) comprising a relief plunger and a biasing spring and passage 116 introduces speed-related pressurized working fluid into valve bore 112 on the same side of the relief plunger as the biasing spring. In this manner the biasing force on the relief plunger which must be overcome to relieve the output pressure of pump 104 is the sum of the biasing force of the spring and the force created by the working fluid from passage 116 on the plunger. An example of such a pressure relief control mechanism, as described above, is discussed in the above-mentioned PCT Patent Application WO06032131A1 with respect to the embodiment shown in FIG. 5 therein.

If pump 104 is a variable displacement pump, passage 116 can introduce the speed-related pressurized working fluid into the displacement control mechanism of pump 104 to alter its displacement accordingly as will be apparent to those of skill in the art.

If desired, for example for a V6 engine with a sixty degree V angle, balancer 100 can be fabricated with a single balance shaft 28 and, in such a case, drive gear or sprocket 48 will be mounted on balance shaft 28.

FIGS. 5 and 6 show another dynamic balancer 200 with a speed-related control mechanism in accordance with the present invention and wherein like components to those of the embodiment of FIGS. 1 and 2 and the embodiment of FIGS. 3 and 4 are indicated with like reference numerals.

In balancer 200, gear 204 engages gear 52 to drive balance shaft 28 and gear 204 is a conventional solid gear. A separate pressure generator 208, in the form of a disc in which chamber 60 is formed, is attached to, and rotates with, the end of balance shaft 28 opposite the end to which pump 104 is attached. As with balancer 100, chamber 60 is supplied with low pressure working fluid via center bore 76 and connecting passage 80 and chamber 60 includes at least one outlet 84, distal the center of rotation of balance shaft 28, which communicates with groove 88 such that working fluid pressurized in chamber 60 from the rotation of balance shaft 28 is supplied, via passage 116, to valve bore 112. Again, if pump 104 is a variable displacement pump, passage 116 can introduce the speed-related pressurized working fluid into the displacement control mechanism of pump 104 to alter its displacement accordingly.

If desired, for example for a V6 engine with a sixty degree V angle, balancer 200 can be fabricated with a single balance shaft 28 and, in such a case, drive gear or sprocket 48 will be mounted on balance shaft 28.

As will be apparent form the above, the present invention provides a speed-related pressure signal which can be employed to control a variety of devices, such as a relief valve for a fixed displacement pump or a displacement control mechanism for a variable displacement pump. The invention comprises a dynamic balancer for a prime mover, such as an internal combustion engine, with at least one balance shaft driven at twice the speed of the crankshaft of the engine. A pressure generator on the at least one balance shaft creates an output signal of pressurized working fluid whose pressure is speed-related. In an embodiment, the speed related pressure signal is applied to a device outside the balancer via a suitable passage. In other embodiments of the invention, a working fluid pump is also driven by at least one of the balance shafts of the dynamic balancer and the speed-related pressure signal is applied to the working fluid pump to control its output.

The above-described embodiments of the invention are intended to be examples of the present invention and alterations and modifications may be effected thereto, by those of skill in the art, without departing from the scope of the invention which is defined solely by the claims appended hereto.

1. A dynamic balancer for a prime mover comprising:
a housing;
at least a first balance shaft with an eccentric counterweight rotatably mounted to the housing, the first balance shaft further comprising a pressure generator operable to create a signal of pressurized working fluid whose pressure is related to the rotational speed of the first balance shaft, the signal being available to a controllable device; and
an input drive operable to allow a prime mover to rotate the first balance shaft.

2. The dynamic balancer of claim 1 wherein the controllable device is a pressure relief valve of a fixed displacement working fluid pump.

3. The dynamic balancer of claim 1 wherein the controllable device is a displacement control of variable displacement working fluid pump.

4. The dynamic balancer of claim 1 further including a working fluid pump driven by the first balance shaft, the output of the working fluid pump being controlled by the controllable device.

5. The dynamic balancer of claim 4 wherein the working fluid pump is a fixed displacement pump and the controllable device is a pressure relief valve.

6. The dynamic balancer of claim 4 wherein the working fluid pump is a variable displacement pump and the controllable device is displacement adjuster.

7. The dynamic balancer of claim 1 wherein the input drive rotates the first balance shaft at twice the speed of the prime mover.

8. The dynamic balancer of claim 7 further comprising a second balance shaft and wherein the input drive connects the second balance shaft to the prime mover and the first balance shaft engages a gear on the second balance shaft which counter-rotates the first balance shaft.

9. The dynamic balancer of claim 8 wherein the controllable device is a pressure relief valve of a fixed displacement working fluid pump.

10. The dynamic balancer of claim 8 wherein the controllable device is a displacement control of variable displacement working fluid pump.

11. The dynamic balancer of claim 8 further including a working fluid pump driven by at least one of the first and second balance shafts, the output of the working fluid pump being controlled by the controllable device.

12. The dynamic balancer of claim 11 wherein the working fluid pump is a fixed displacement pump and the controllable device is a pressure relief valve.

13. The dynamic balancer of claim 11 wherein the working fluid pump is a variable displacement pump and the controllable device is displacement adjuster.

14. The dynamic balancer of claim 8 wherein the pressure generator is a chamber rotatable with one of said first and second balance shafts.

15. The dynamic balancer of claim 8, wherein the pressure generator is a chamber within said gear.

16. The dynamic balancer of claim 8, wherein the pressure generator is a chamber formed within and which encircles one of said first and second balance shafts.

17. The dynamic balancer of claim 14, wherein said chamber has at least one inlet receiving pressurized fluid and at least one outlet, said outlets positioned radially outwardly of said inlets, whereby pressurized fluid within said chamber is pressurized proportionally to the rotational speed of the first balance shaft.

18. The dynamic balancer of claim 17, wherein said housing has a wall in sealed thrust engagement with said pressure generator, said wall having an annular groove receiving pressurized working fluid from said outlet and a passage communicating with the groove to deliver the pressurized fluid to said controllable device.

19. The dynamic balancer of claim 15, wherein said chamber has at least one inlet receiving pressurized fluid and at least one outlet, said outlets positioned radially outwardly of said inlets, whereby pressurized fluid within said chamber is pressurized proportionally to the rotational speed of the first balance shaft.

20. The dynamic balancer of claim 16, wherein said chamber has at least one inlet receiving pressurized fluid and at least one outlet, said outlets positioned radially outwardly of said inlets, whereby pressurized fluid within said chamber is pressurized proportionally to the rotational speed of the first balance shaft.
